(19) United States
(12) Patent Application Publication
(10) Pub. No.: US 2004/0074970 A1
(43) Pub. Date: Apr. 22, 2004

(54) Method and device for communicating data contained in one or several barcodes

(76) Inventor: Jean-Loic Fauchille, Lambersart (FR)

Correspondence Address: HARRISON & EGBERT, 412 MAIN STREET, 7TH FLOOR, HOUSTON, TX, 77002, US

(21) Appl. No.: 10/149,493

(22) PCT Filed: Oct. 16, 2001
(86) PCT No.: PCT/FR01/03194

(30) Foreign Application Priority Data
Oct. 16, 2000 (FR) 00/13239

(51) Int. Cl. G06K 7/10

(52) U.S. Cl. 235/462.46

(57) ABSTRACT

The invention relates to a method and a device for communicating information contained in one or several barcodes towards one or several remote servers. A method wherein:

said pieces of information are acquired,

said pieces of information are transformed into at least one message, so-called barcode message, ready to be sent to said server by a transmission network, also enabling the communication of messages containing other types of information,

the content of said barcode(s) is transmitted towards the servor(s) thanks to a hand-held transmission/reception module (4), capable of transmitting said barcode messages as well as the messages containing other types of information on said network. The invention also concerns a system for exchanging information contained in one or several barcodes comprising at least one such communication device.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention relates to a method and a device for communicating information contained in one or several barcodes as well as a system for exchanging information contained in one or several barcodes comprising at least one such device.

Barcodes mean codes formed of a set of characters, for example printed or written characters, whereas the characters are composed, notably, of distinct bars of different shapes and/or sizes, parallel to one another, whereby the value of said code is determined by the combination of the characters selected.

### BACKGROUND OF THE INVENTION

Currently, to know the information contained in a barcode, it is known to use fixed terminals fitted with reading means. These terminals are linked by a wire computer network to a server which, in response, transmits the information to the terminal.

Such installations can be encountered, for example, in department stores, hyper or supermarkets, wherein the terminals are implanted either at the check-outs or inside the stores to enable the customer to verify a piece of information, notably a price, before purchasing a product.

The shortcoming of such installations is that they require reaching a fixed point in order to be able to read barcodes and to transmit information.

In other domains, hand-held boxes are also known for reading barcodes which enable to store barcodes after reading.

In a first type of installations, these boxes are fitted with means for connection lo a fixed terminal of a wire computer network thanks to which the stored barcodes can be transmitted to a server. In a second type of installations, the hand-held boxes are fitted with short distance radio transmission means, liable to transmit the barcode messages to the terminals of a wire computer network, providing they are close enough to said terminals.

Even if such solutions enable to read barcodes, without needing to move the objects affected, they still imply to reach a given position to enable the transmission of information. Besides, the terminals used as an interface between the boxes arid their network serve specifically to that application.

It should also be noted that, with hand-held reading boxes known currently, it is not possible to have an information feedback regarding the content of the barcodes.

The purpose of this invention is to provide a method and a device for communicating information contained in one or several barcodes which remedy the shortcomings mentioned above and enable to read and to transmit said information without depending on a fixed point, dedicated to such an application.

Another purpose of this invention is to provide a method and a device for communicating information contained in one or several barcodes which enable an information feedback.

Another purpose of this invention is to provide a method and a device for communicating information contained in one or several barcodes, which enable secured transmission of said information.

Another purpose of this invention is to provide a method and a device for communicating information contained in one or several barcodes whereof the implementation cost remains low, while enabling transmission over a very long distance.

An advantage of the invention is to enable to develop the number and the nature of the applications of the barcodes.

Other purposes and advantages of the invention will appear during the following description which is given only for indicative purposes and does not purport to limit said invention.

### BRIEF SUMMARY OF THE INVENTION

The invention relates first of all to a method and a device for communicating information contained in one or several barcodes towards one or several remote servers, a method wherein:

said pieces of information are acquired,

said pieces of information are transformed into at least one message, so-called barcode message, ready to be sent to said server by a transmission network, also enabling the communication of messages containing other types of information,

the content of said barcode(s) is transmitted towards the server(s) thanks to a hand-held transmission/reception module, capable of transmitting said barcode messages as well as the messages containing other types of information on said network.

The invention also relates to device for communicating pieces of information contained in one or several barcodes towards one or several remotp servers, wherein said device comprises:

reading means for acquisition of said information,

processing means capable of transforming said information into at least one message, so-called barcode message, ready to be sent to said server(s) over a transmission network, also enabling the communication of messages containing other types of information,

at least one hand-held transmission/reception module, capable of transmitting said barcode messages as well as said messages containing other types of information over said network.

The invention also relates to a system for exchanging information contained in one or several barcodes comprising at least one communication device such as described above, operating with a given transmission network, at least one sever to which the barcode messages transmitted by said device are intended and means for connecting said server(s) over said network.

### BRIEF DESCRIPTION OF THE SEVERAL VIEWS OF THE DRAWINGS

The invention will be understood better when reading the following description accompanied by the appended drawings wherein:

FIG. 1 describes schematically an example of a device for communicating information contained in barcodes according to the invention,

FIG. 2 describes schematically an example of a system for exchanging information contained in barcodes according to the invention.

### DETAILED DESCRIPTION OF THE INVENTION

The invention relates first of all to a method for communicating information contained in one or several barcodes towards one or several remote servers.

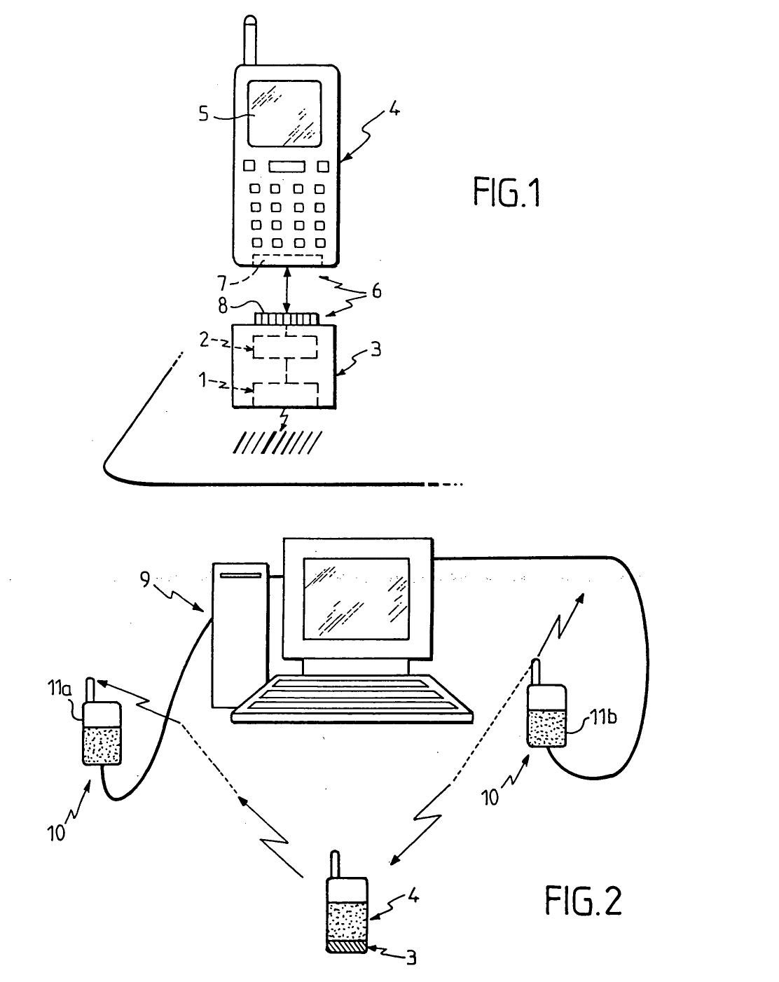

As illustrated on FIGS. 1 and 2 according to the invention, said pieces of information are acquired first of all. Said pieces of information are then transformed into at least one message, so-called barcode message, ready to be sent to said server(s) over a transmission network.

The transmission network operated according to the method of the invention is selected among the transmission networks which also enable the communication of messages containing other types of information such as, notably, voice, texts, images or others. It is therefore a transmission network that is not dedicated to the sole communication of the barcode messages.

It can be formed, for instance, of a pre-existing Wide Area Network (WAN), such as a cellular telephony network like the Global System for Mobile Communications (GSM).

Then the content of said barcode(s) is transmitted towards said server(s); thanks to a hand-held transmission/reception module, capable of transmitting said barcode messages as well as said messages containing other types of information over said network.

Thanks to the transmission/reception module 4, it is not necessary to reach fixed terminals any longer. Moreover, the use of a transmission network, which is not dedicated to the sole communication of the barcodes, limits the cost of implementation.

According to a first embodiment, the acquisition of information and their transformation into barcode messages is performed thanks to means integral with said hand-held module 4.

According to another embodiment, as illustrated, said barcode message(s) is(are) sent to said hand-held module 4 while connecting said module to a reading assembly 3, comprising reading means 1, enabling the acquisition of said information, and processing means 2, enabling the establishment of said barcode messages, whereas said reading assembly 3 is also intended to be hand-held.

Quite naturally, said reading assembly 3 is connected to said hand-held module 4 while said barcode message(s) is(are) sent to said hand-held module 4 but still, at least, during the acquisition of said information and/or the establishment of said barcode messages. The connection can then be permanent.

According to a preferred embodiment data is loaded into said reading assembly 3 from said hand-held module 4 during the establishment of said barcode messages, said data is intended to be part of the composition of said barcode messages and/or to direct their course. Thus, the data to be stored in the reading assembly 3 is limited.

For exemplification purposes, at least at one a memory location of said hand-held module 4, a user identification code is stored and/or a network address of one or several said servers and, during the establishment of said barcode messages, said memory locations are made known to said reading assembly 3. Said reading assembly 3 can then interrogate said hand-held module 4 in order to load said codes and/or addresses.

The latter can then be part of the composition of the barcode message without needing to be input manually. Besides, placing the address and/or the identification codes used at the hand-held module 4 enables to benefit from reading assemblies that can operate with any hand-held module.

Besides, the user identification codes will enable to manage, for example, subscription systems.

Said memory location(s) of the hand-held module 4 where the processing means 2 uin find the data relating to the codes and/or addresses could be stored in said reading assembly 3. Alternately, they can depend on the barcode read, for instance, on the value of its first character(s).

According to a particular embodiment, a plurality of servers are provided, each dedicated to a given function, then at said hand-held modules 4 at least as many memory locations as servers are provided, the address on the network of one given or said servers is stored in each memory location and one of said memory locations is stored in said reading assembly 3.

Thus, a reading assembly 3 can be associated a given server and, consequently, a given function corresponding to that which can be ascribed to the server.

Still, the address on the network of said hand-hold module 4 at the origin of said barcode message(s) transmitted can also be tranimitted to said server(s). Said server(s) could send to said hand-held module 4 a response relating to said barcodes which can be visualised thanks to said module.

Besides, said reading assembly 3 can be supplied from an energy source provided in said hand-held module 4.

According to a first embodiment, said barcodes are stored as they are acquired in said reading assembly 3 and they are sent in bursts to said handheld module 4. According to another embodiment, said barcode message is transmitted after each acquisition of a given barcode.

The invention also relates to a device for communicating information contained in one or several barcodes towards one or several remote servers. It can also ser/e to the implementation of the method described above.

Said device comprises first of all reading means 1 to acquire said information. They can be, for example, laser drivers known to the man of the art.

Said device also comprises processing means 2, capable of transforming said information into at least one message, so-called barcode message, ready to be sent to said server(s) by a transmission network, also enabling the communication of messages containing other types of information. Said processing means 2 are formed, for example, of a micro-programmed circuit, associated with possible memories. They enable to perform, for instance, the following functions:

receiving the characters read and decoded by said reading means 1,

stringing the characters composing said barcode message, and

supplying said barcode message downstream for its transmission.

The communication device according to the invention still comprises at least one hand-held transmission/reception module 4, capable of transmitting said barcode, messages as well as said messages containing other types of information on said network.

The latter is formed, for example, of a hand-held telephone of a cellular communication network. It is, notably, a GSM-type wireless telephone, capable of transmitting voice and/or data, via relay stations distributed over a vast territory forming a network operated besides for other types of communication. The barcode messages may be in the form of SMS (Short Message Service) messages. They can also be transmitted thanks to the WAP (Wireless Application Protocol) protocol.

Said reading means 1 and said processing means 2 form for example an assembly that is hand-held, a so-called reading assembly 3. Said assembly is formed, for example, of a box integral with said micro-programmed circuit and/or said memories.

Said box can moreover be fitted with a trigger button whereof the actuation will cause a barcode to be read, a corresponding barcode message to be established and to be supplied downstream. It can also exhibit several light-indicators to visualise its operation. Its size will be as small as possible.

According to this embodiment, the device also comprises means 6 to connect said reading assembly 1 and said hand-held module 4 and to send said barcode message(s) to said hand-held module 4.

Said connection means 6 are formed, notably, on the one hand, of a standardized outlet 7 provided at the said hand-held telephone 4 and, on the other hand, of a connector 8, provided at said reading assembly 3 and capable of being plugged into said standardised outlet 7. For GSM telephones, the latter is formed, for example, of the connector situated normally at the basis of said telephones. A linking cable could also be used to link said reading assembly and said hand-held module, notably between said outlets.

Said means to send said barcode messages to said hand-held module 4 are formed, notably, of a modem situated in said hand-held telephone. For GSM telephones, it can be, for example, the modem provided normally in said telephones. It can be a specific modem, notably situated in the box 3.

Information exchanges between the micro-programmed of the processing means 2 and the mobile telephone make use, for example, of the ‘AT’-type standardised commands at European level under the references ETSI 07.07 and 07.05. They can, be realised using a serial link as information exchanges between the laser driver of the reading means 1 and said micro-programmed.

Said processing means 2 will be ultimately capable of authorising the loading of data from said hand-held module 4 into said reading assembly 3. As mentioned previously, they can bo addresses of the servers and/or user identification codes.

For hand-held telephones, notably of GSM type, the memory locations used for the date to be loaded are situated, for example, on the memory units provided normally in said telephones or still, advantageously, on the SIM cards encountered in some of them and/or smart cards to be inserted into a reading slot of the hand-held module 4.

According to another embodiment, said reading means 1 and said processing means 2 can be integral with said hand-held module 4.

Said hand-held module 4 can comprise a screen 5, capable of authorising the visualisation of possible responses from the server(s) affecting the content of the barcode. For GSM telephones, it will be notably the screen provided normally on said telephones, for visualising information concerning telephone communications.

Besides, said connection means 6 can be capable of authorising, on top of the exchange of data between said hand-held module 4 and said reading assembly 3, the passage of a power supply. Said reading assembly 3 can thus be supplied from an energy source of the hand-held module 4. For GSM telephones, said energy source will be formed, for example, of the battery encountered normally in said telephones.

The invention also relates to a system for exchanging information contained in one or several barcodes comprising at least one communication device such its described above, operating with a given transmission network, at least one server 9 for which the barcode messages transmitted are intended and means 10 for connecting said server(s) 9 on said network.

Said server(s) 9 are formed, for instance of a microcomputer. They process the barcode messages received, for example according to the following functions:

acquisition of the barcode message,

verification of the identification code,

access to a database contained in the microcomputer or to a remote database linked by a computer network to said microcomputer, and

possible preparation of a response message intended for the hand-held module 4.

Said connections means 9 or servers 9 are formed, notably, of one or several transmission/reception hand-held modules, i,e., for GSM networks, hand-held telephones 11a, 11b. It can be provided such a hand-held telephone 11a for the reception of barcode messages and such a telephone 11b for the transmission of the responses. According to a variation, both these functions can be fulfilled ty a single hand-held telephone. This global solution is thus based upon distributed intelligence.

For exemplification purposes, the invention can be used for logistic follow-up of products or documents, taking stocks, ordering or purchasing products or services or still remote information.

Naturally, other embodiments or other usages, readily understandable to the man of the art, could have been contemplated without departing from the framework of the invention.

I claim:

1. A method for communicating information contained in one or several barcodes towards one or several remote servers, wherein:
said pieces of information are acquired,
said pieces of information are transformed into at least one message, so-called barcode message, ready to be sent to said server by a transmission notwork, also enabling the communication of messages containing other types of information,
the content of said barcode(s) is transmitted towards the server(s) thanks to a hand-held transmission/reception module (4), capable of transmitting said barcode messages as well as the messages containing other types of information on said network, and wherein;
the barcode message(s) is(are) sent to said hand-held module (4) while connecting said module to a reading assembly (3), comprising reading means (1), enabling, the acquisition of said information, and processing means (2), enabling the establishment of said barcode messages, whereas said reading assembly (3) is also intended to be hand-held,
said reading assembly (3) is connected to said hand-held module (4) at least during the acquisition of said information and/or the establishment of said barcode messages,
data is loaded into said reading assembly (3) from said hand-held module (4) during the establishment of said barcode messages, said data is intended to be part of the composition of said barcode messages and/or to direct their course.

2. A method according to claim 1, wherein at least at one a memory location of said hand-held module (4), a user identification code is stored and/or a network address of one or several said servers and, during the establishment of said barcode messages, said memory locations are made known to said reading assembly (3), then said reading assembly (3) can interrogate said handheld module (4) in order to load said codes and/or addresses.

3. A method according to claim 2, wherein a plurality of servers are provided, each dedicated to a given function, then at said hand-held modules (4) at least as many memory locations as servers are provided, the address on the network of one given of said servers is stored in each memory location and one of said memory locations is stored in said reading assembly (3).

4. A method according to claim 1, wherein the address on the network of said hand-held module (4) at the origin of said barcode messages transmitted is also transmitted to said server(s).

5. A method according to claim 4, wherein said server(s) transmit to the hand-held module (4) at the origin of the barcode message(s) a response depending on said barcode(s).

6. A method according to claim 1, wherein said reading assembly (3) is supplied from an energy source provided in said hand-held module (4).

7. A method according to claim 1, wherein said barcode message is sent after each acquisition of a given barcode.

8. A device for communicating the information contained in one or several barcodes towards one or several remote servers, said device comprising:
a hand-held reading assembly (3), comprised of reading means (1) to acquire said information, and processing means (2), capable of transforming said information into at least one message, a so-called barcode message, ready to be sent to said servers by a transmission network, also enabling communication of messages containing other types of information,
at least one hand-held transmission/reception module (4), capable of transmitting said barcode message as well as messages containing other types of information over said network,
means for connecting said reading assembly (3) and said hand-held module (4) and means to send said barcode message(s) to said hand-held module (4), whereas said hand-held module (4) is comprised of an energy supply source and said means for connecting (6) are capable of authorising, in addition to data exchanges between said hand-held module (4) and said reading assembly (3), energy powering of said reading assembly (3) from the energy supply source of the hand-held module (4).

9. A device according to claim 8, wherein said hand-held module is a hand-held telephone of a cellular communication network, said telephone being capable of transmitting voice and/or data.

10. A device according to claim 9, wherein said connection means (6) are comprised of a standardized outlet (7), provided at said hand-held telephone (4) and a connector (8), provided at said reading assembly (3) and capable of being plugged into said standardized outlet.

11. A device according to claim 9, wherein said means to send said barcode messages to said hand-held module (4) are formed, notably, of a modem situated in said hand-held telephone.

12. A device according to claim 8, wherein said processing means are capable of authorizing the loading of data from said hand-held module (4) into said reading assembly (3).

13. A device according to claim 8, wherein said hand-held module (4) comprises a screen (5), capable of authorising the visualization of possible response from the server(s) affecting the content of the barcodes.

14. A system for exchanging information contained in one or several barcodes comprising at least one communication device according to claim 8, operating with a given transmission network, at least one server (9) to which the barcode messages transmitted by said device are intended and means (10) for connecting said server(s) (9) over said network.

15. A system according to claim 14, wherein said connections means (10) of said server(s) (9) are formed of hand-held transmission/reception modules of said network.
